(19) United States
(12) Patent Application Publication
(10) Pub. No.: US 2025/0123988 A1
(43) Pub. Date: Apr. 17, 2025

(54) ADJUSTMENT OF PORT CONNECTIVITY OF AN INTERFACE

(71) Applicant: Intel Corporation, Santa Clara, CA (US)

(72) Inventors: Liron ELMALEH, Beer Tuvia (IL); Eliel LOUZOUN, Jerusalem (IL); Yosef Hai AMAR, Ashdod (IL); Alon MEIR, Jerusalem (IL)

(21) Appl. No.: 19/000,121

(22) Filed: Dec. 23, 2024

(51) Int. Cl. G06F 13/42; G06F 13/40

(52) U.S. Cl. CPC G06F 13/4221; G06F 13/4022; G06F 2213/0026

(57) ABSTRACT

Examples described herein relate to a network interface device. The network interface device includes a host interface; a network interface; and a direct memory access (DMA) circuitry. In some examples, the host interface includes circuitry to: apply a first configuration of Peripheral Component Interconnect Express (PCIe) upstream ports and downstream ports and without reboot of the network interface device, apply a second configuration to adjust routing of communication among devices coupled to the PCIe upstream ports and downstream ports.

### BACKGROUND

In computers, device interfaces are used to connect a circuit board, such as a motherboard, to provide communication among a processor and one or more peripheral devices (e.g., graphics processor, memory, and networking). For example, a device interface connects external host devices, external endpoint devices, internal hosts, and internal endpoints through its Peripheral Component Interconnect Express (PCIe) connections. Device interfaces support various topologies of connections. In different topologies, there could be different bandwidth and throughput requirements for connected-components. The limitation depends on the PCIe speed and width of each PCIe link between the product and the external component (host or endpoint).

### BRIEF DESCRIPTION OF THE DRAWINGS

FIG. 1 depicts an example system.

FIG. 2 depicts an example of a logical view of a first configuration.

FIG. 3 depicts an example second configuration.

FIG. 4 depicts an example process.

FIGS. 5A and 5B depict example network interface devices.

FIG. 6 depicts an example network interface device.

FIG. 7 depicts an example system.

### DETAILED DESCRIPTION

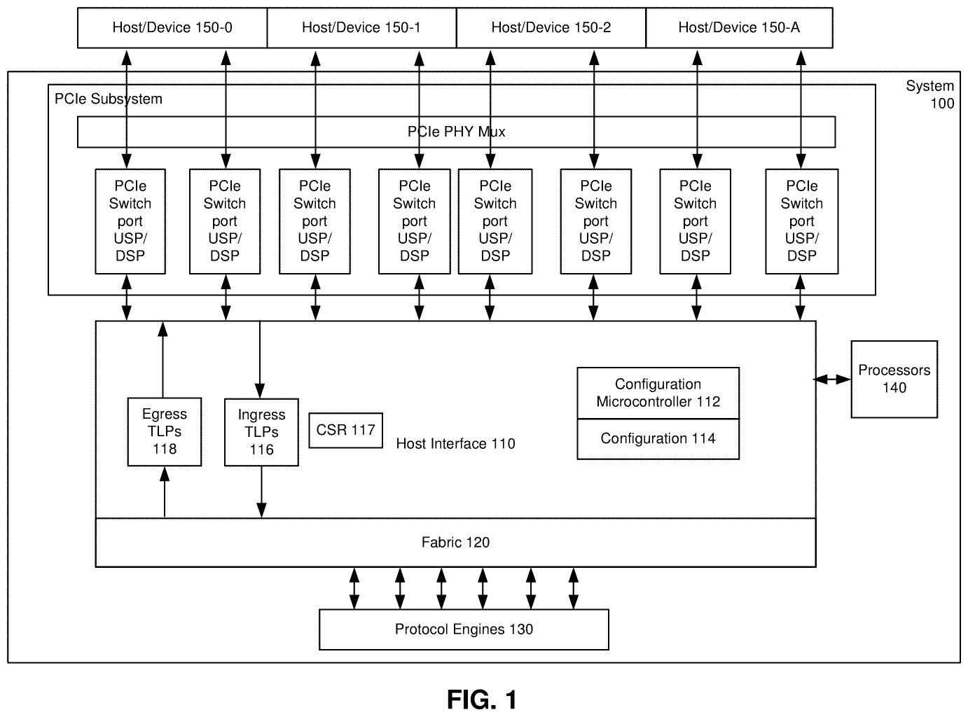

FIG. 1 depicts an example topology configuration of a host interface. The topology can provide connections of 16 lanes to 4 external hosts or devices. However, other numbers of lanes, hosts, and devices can be connected. In PCIe subsystem, PCIe lanes can be allocated per configuration (e.g., x16, x8, x4, etc.).

System 100 can include one or more of: a storage device, accelerator, graphics processing unit (GPU), network interface device, or other circuitry. System 100 can utilize a topology of upstream and downstream ports that are configured prior to boot of the device. Various examples can route communications between an endpoints and hosts. As described herein, system 100 can dynamically adjust a configuration of one or more PCIe switches of host interface 110 to change a topology representative of one or more PCIe endpoints mapped to upstream (U) and downstream (D) ports. The upstream and downstream ports can be assigned by firmware executed by processors 140 and stored in non-volatile memory.

One or more of host processors 150-0 to 150-A, where A is an integer, or processors 140 can include one or more of: a central processing unit (CPU), a processor core, graphics processing unit (GPU), neural processing unit (NPU), general purpose GPU (GPGPU), field programmable gate array (FPGA), application specific integrated circuit (ASIC), tensor processing unit (TPU), matrix math unit (MMU), or other circuitry. A processor core can include an execution core or computational engine that is capable of executing instructions. A core can access to its own cache and read only memory (ROM), or multiple cores can share a cache or ROM. Cores can be homogeneous (e.g., same processing capabilities) and/or heterogeneous devices (e.g., different processing capabilities). Frequency or power use of a core can be adjustable. A core can be sold or designed by Intel®, ARM®, Advanced Micro Devices, Inc. (AMD)®, Qualcomm®, IBM®, Nvidia®, Broadcom®, Texas Instruments®, or compatible with reduced instruction set computer (RISC) instruction set architecture (ISA) (e.g., RISC-V), among others.

Host interface 110 can perform switching operations based on configuration 114 to route Transaction Layer Packet (TLP) communications among external host processors 150-0 to 150-A, external devices 150-0 to 150-A, internal protocol engines 102, configuration microcontroller 112, and/or processors 104. Configuration 114 can apply a topology with a PCIe tree that enumerates internal and external endpoints. For example, a topology can include one or more of the following: connection to zero or more processors external to the device (e.g., hosts 150-0 to 150-A (e.g., PCIe physical layer interface (PHY) to central processing unit (CPU), PCIe PHY to graphics processing unit (GPU), or others); connection to zero or more endpoint devices external to the device (e.g., devices 150-0 to 150-A (e.g., storage devices, accelerators, network interface device, or others)); connection to zero or more internal processors within the device (e.g., processors 140 and/or configuration microcontroller 112; and connection to zero or more internal endpoints within the device (e.g., protocol engines 130). System 100 can allow various topologies to be exposed and flexible allocation of resources and flexible switching topologies. A PCIe tree of each host in each topology can change whereby previously connected devices can be exposed without requiring reboot of the host. Host interface 110 can provide connectivity to the external and internal devices by connection to physical PCIe Endpoint (EP), or PCIe Root-Port (RP) based on configuration 114.

Various examples of host interface 110 can adjust processors and devices of system 100 that can communicate with external processors and devices 150-0 to 150-A without re-booting system 100. For example, host interface 110 can provide flexible routing schemes to provides PCIe switch interfaces to hosts and devices. Host interface 110 can include physical PCIe switch port circuitries as interfaces to the hosts and the external devices, while firmware executed by microcontroller can configure a PCIe switch to communications to and from endpoints in system 100 and root-ports in system 100.

A device or processor can be added to a PCIe port by a hot plug event. Configuration microcontroller 112 can perform a configuration flow of a PCIe topology specified by configuration 114 to perform enumeration to detect and initialize devices connected to PCIe interfaces. In some examples, connection among internal and external devices can be changed without reset of system 100. In some examples, connection among enumerated and detected internal and external devices can be adjusted to remove a previously enumerated and detected internal or external device without reset of system 100.

For example, bus ranges registers can define the PCIe identifier (ID) bus range to forward ID-based routing requests across interconnect fabric 120. Memory Base and Memory Limit registers can define the memory mapped address ranges to forward memory transactions from External host to its external devices through interconnect fabric 120. Memory space base address registers (BAR) for the internal endpoint functions can store rules that determine the destination of a memory request. For example, to adjust routing among devices, configuration microcontroller 112 can adjust a destination of internal or external device to route TLPs that are routed by identifier (ID) to the proper destination internal or external device; adjust destination internal or external device MMIO address ranges of destination internal or external device to route TLPs that are routed by identifier (ID) to the proper destination internal or external device; or associating a base address register (BAR) with destination of internal or external device to route TLPs to the proper destination internal or external device.

For example, PCIe configuration packets can be routed to configuration microcontroller 112 for processing. Microcontroller 112 can either process the PCIe configuration packet internally or route the PCIe configuration to an external device, depending on the PCIe tree of that host. Accordingly, one or more of host 150-0 to 150-A can access an endpoint in system 100 to perform a configuration operation (e.g., adjust a topology or change connectivity among devices and hosts) or a root port in system can access an endpoint device to perform a configuration operation.

Based on programmable routing rules, configured by microcontroller 112, ingress TLP 116 and configuration status register (CSR) decoder 117 can route memory requests and completions of memory mapped input output (MMIO) and direct memory access (DMA) flows. For ingress TLPs, ingress TLP processing circuitry (ITP) 116 can perform: decoding TLP from PCIe link to action, MMIO address decoding, handling of ingress TLPs (e.g., error reporting, enforcement of ordering of different types of TLPs (e.g., posted, non-posted, completion), TLP completion tracking, or others), accessing vector tables for interrupts, or others.

For egress TLPs, egress TLPs 118 can perform: receive action and encode TLP and send to PCIe link, MMIO address decoding, formatting of egress TLPs (e.g., error reporting, enforcement of ordering of different types of TLPs (e.g., posted, non-posted, completion), TLP completion tracking, or others), accessing vector tables for interrupts, or others.

Fabric 120 can include one or more switches that route communications to various ports according to configuration 114.

Protocol engines 130 can include perform operations including one or more of: storage access (e.g., NVMe or NVMe-oF reads or writes), Address Translation Engine (ATE), local area network (LAN), remote direct memory access (RDMA), compression/decompression, encryption/decryption, or other accelerated operations. Protocol engine 130 can provide commands and communications between an application and operating system (OS), executed by processors on one or more of host 150-0 to 150-A, and system 100 in accordance with one or more applicable application program interfaces (APIs) or protocols (e.g., Non-Volatile Memory Express (NVMe) or others). In some examples, protocol engine 160 can be associated with system 100 (e.g., a network interface device, storage controller, storage device (e.g., NVMe drive), memory pool controller, graphics processing unit, cryptographic processor, or other device).

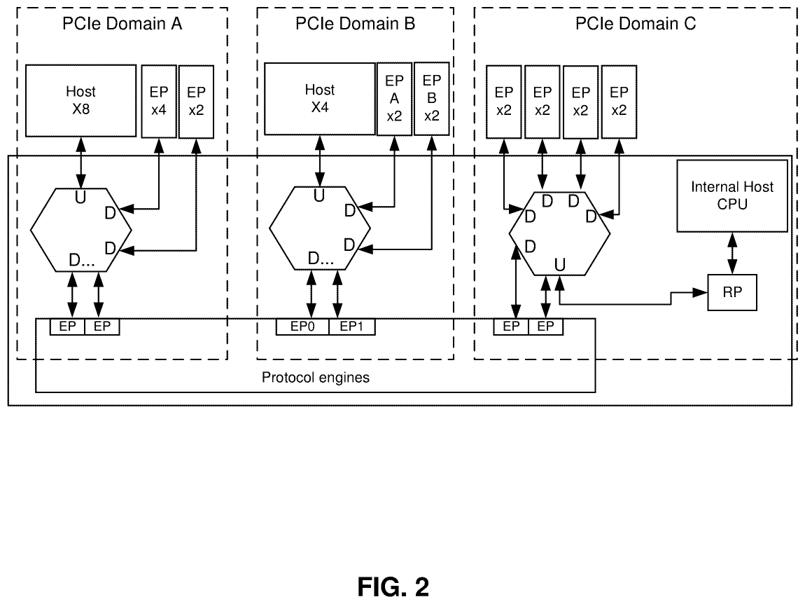

FIG. 2 depicts an example of a logical view of a first configuration. Logically, a host interface can be a set of separated PCIe switches in PCIe domains A, B, and C. PCIe Domain A exposes a PCIe upstream switch port (U) to a processor and PCIe downstream switch ports (D) to four endpoints. PCIe Domain B exposes a PCIe upstream switch port (U) to a second processor and PCIe downstream switch ports (D) to a second group of four endpoints, including protocol engines. Domain B connects endpoint devices EP A and EP B to EP 0 and EP 1, respectively. PCIe Domain C exposes a PCIe upstream switch port (U) to a third processor that is internal to a system and PCIe downstream switch ports (D) to a third group of six endpoints, including protocol engines.

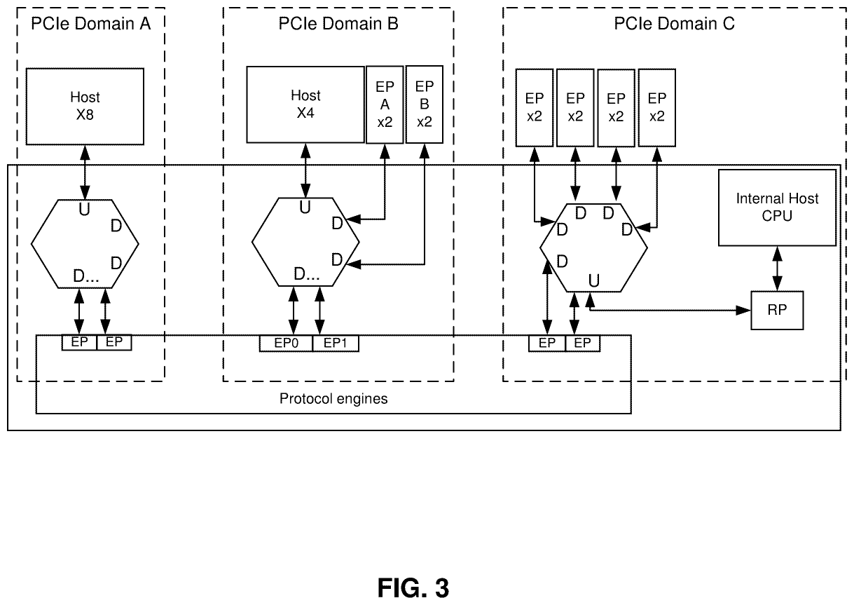

FIG. 3 depicts an example second configuration that adjusts the endpoint devices coupled in domains A and B. Domain A removed two endpoint devices connected to downstream ports. Domain B changed two connections of endpoint devices EP A and EP B to be connected to EP 1 and EP 0, respectively. Domain C is unchanged. Processors in domain C can execute a process (e.g., virtual machine (VM) or firmware) to perform a re-enumeration of devices in domains A and B.

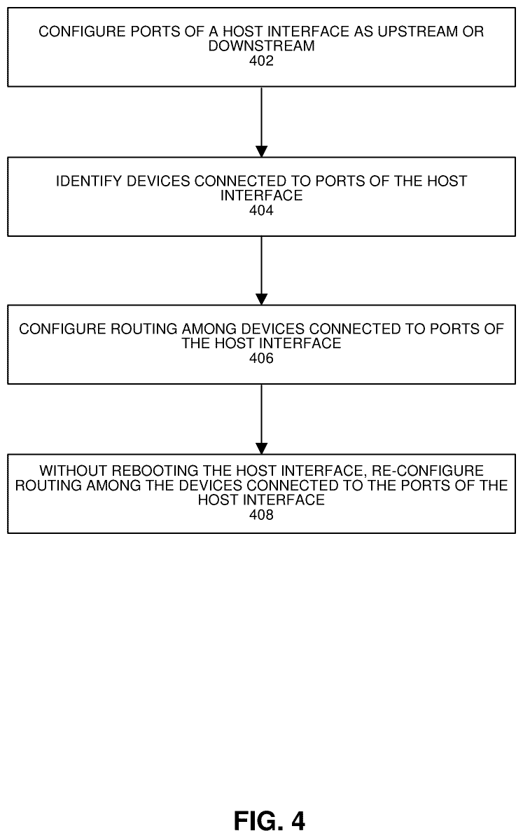

FIG. 4 depicts an example process. The process can be performed by a processor, host interface, or PCIe switch circuitry. At 402, a configuration can be applied to associate ports of the host interface to upstream ports or downstream ports. At 404, host processors and devices connected to the ports of the host interface can be identified. At 406, communications between connected host processors and devices can be configured so that the host interface routes the communications from sources to destinations. For example, to configure routing of TLP communications among host processors, a configuration microcontroller of the host interface can set a routing configuration to: route TLPs that are routed by identifier (ID) to the proper destination; or associate a base address register (BAR) with a destination to route TLPs to the proper destination. At 408, without rebooting the host interface, routings between source and destination host processors or devices can be adjusted by changing the routing configuration to adjust IDs to the proper destination.

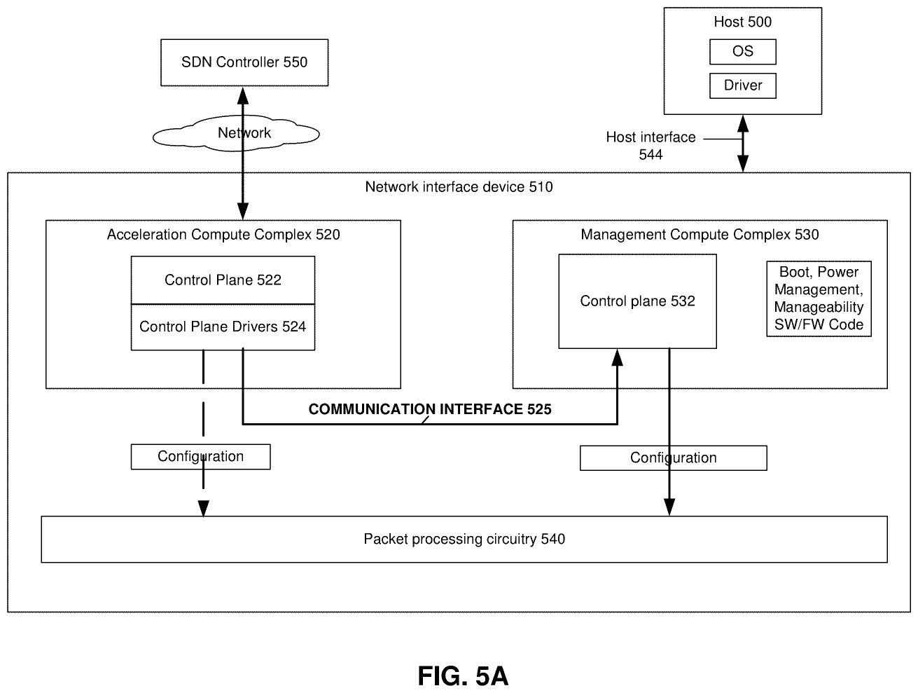

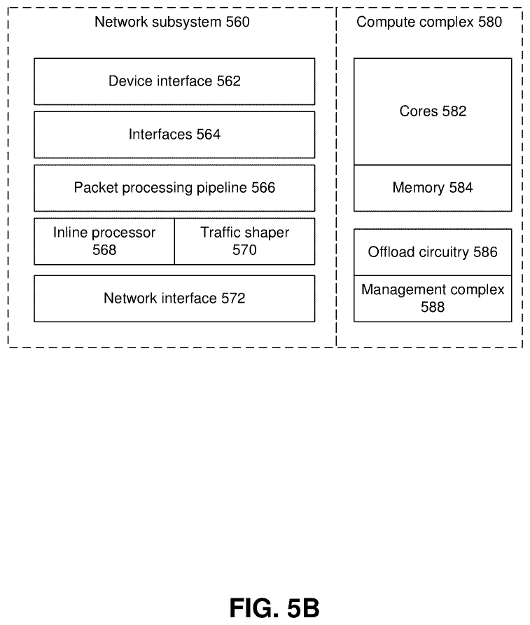

FIG. 5A depicts an example system. Host 500 can include processors, memory devices, device interfaces, as well as other circuitry such as described with respect to one or more of FIGS. 1 and/or 7. Processors of host 500 can execute software such as processes (e.g., applications, microservices, virtual machine (VMs), microVMs, containers, processes, threads, or other virtualized execution environments), operating system (OS), and device drivers. An OS or device driver can configure network interface device or packet processing device 510 to utilize one or more control planes to communicate with software defined networking (SDN) controller 550 via a network to configure operation of the one or more control planes. Host 500 can be coupled to network interface device 510 via a host or device interface 544.

As described herein, communication interface 525 and/or device interface 544 can be configured as a PCIe switch or host interface to provide communications among host 500, ACC 520, MCC 530, and/or packet processing circuitry 540. Routing of communications among host 500, ACC 520, MCC 530, and/or packet processing circuitry 540 can be adjusted by a change of configuration, as described herein.

Network interface device 510 can include multiple compute complexes, such as an Acceleration Compute Complex (ACC) 520 and Management Compute Complex (MCC) 530, as well as packet processing circuitry 540 and network interface technologies for communication with other devices via a network. ACC 520 can be implemented as one or more of: a microprocessor, processor, accelerator, field programmable gate array (FPGA), application specific integrated circuit (ASIC) or circuitry described at least with respect to FIGS. 5B and/or 7. Similarly, MCC 530 can be implemented as one or more of: a microprocessor, processor, accelerator, field programmable gate array (FPGA), application specific integrated circuit (ASIC) or circuitry described at least with respect to FIGS. 2, 5, and/or 5B. In some examples, ACC 520 and MCC 530 can be implemented as separate cores in a CPU, different cores in different CPUs, different processors in a same integrated circuit, different processors in different integrated circuit. In some examples, circuitry and software of network interface device 510 can be configured to determine whether to divert a packet to a buffer in supplemental memory or drop packets and when to egress packets, as described herein.

Network interface device 510 can be implemented as one or more of: a microprocessor, processor, accelerator, field programmable gate array (FPGA), application specific integrated circuit (ASIC) or circuitry described at least with respect to FIGS. 2, 5, and/or 5B. Packet processing pipeline circuitry 540 can process packets as directed or configured by one or more control planes executed by multiple compute complexes. For example, processing pipeline circuitry 540 can be configured to determine whether to store packets in a buffer in memory of network interface 750 or another device or drop packets and when to egress packets, as described herein. In some examples, ACC 520 and MCC 530 can execute respective control planes 522 and 532.

SDN controller 550 can upgrade or reconfigure software executing on ACC 520 (e.g., control plane 522 and/or control plane 532) through contents of packets received through packet processing device 510. In some examples, ACC 520 can execute control plane operating system (OS) (e.g., Linux) and/or a control plane application 522 (e.g., user space or kernel modules) used by SDN controller 550 to configure operation of packet processing pipeline 540. Control plane application 522 can include Generic Flow Tables (GFT), ESXi, NSX, Kubernetes control plane software, application software for managing crypto configurations, Programming Protocol-independent Packet Processors (P4) runtime daemon, target specific daemon, Container Storage Interface (CSI) agents, or remote direct memory access (RDMA) configuration agents.

In some examples, SDN controller 550 can communicate with ACC 520 using a remote procedure call (RPC) such as Google remote procedure call (gRPC) or other service and ACC 520 can convert the request to target specific protocol buffer (protobuf) request to MCC 530. gRPC is a remote procedure call solution based on data packets sent between a client and a server. Although gRPC is an example, other communication schemes can be used such as, but not limited to, Java Remote Method Invocation, Modula-3, RPyC, Distributed Ruby, Erlang, Elixir, Action Message Format, Remote Function Call, Open Network Computing RPC, JSON-RPC, and so forth.

In some examples, SDN controller 550 can provide packet processing rules for performance by ACC 520. For example, ACC 520 can program table rules (e.g., header field match and corresponding action) applied by packet processing pipeline circuitry 540 based on change in policy and changes in VMs, containers, microservices, applications, or other processes. ACC 520 can be configured to provide network policy as flow cache rules into a table to configure operation of packet processing pipeline 540. For example, the ACC-executed control plane application 522 can configure rule tables applied by packet processing pipeline circuitry 540 with rules to define a traffic destination based on packet type and content. ACC 520 can program table rules (e.g., match-action) into memory accessible to packet processing pipeline circuitry 540 based on change in policy and changes in VMs.

For example, ACC 520 can execute a virtual switch such as vSwitch or Open vSwitch (OVS), Stratum, or Vector Packet Processing (VPP) that provides communications between virtual machines executed by host 500 or with other devices connected to a network. For example, ACC 520 can configure packet processing pipeline circuitry 540 as to which VM is to receive traffic and what kind of traffic a VM can transmit. For example, packet processing pipeline circuitry 540 can execute a virtual switch such as vSwitch or Open vSwitch that provides communications between virtual machines executed by host 500 and packet processing device 510.

MCC 530 can execute a host management control plane, global resource manager, and perform hardware registers configuration. Control plane 532 executed by MCC 530 can perform provisioning and configuration of packet processing circuitry 540. For example, a VM executing on host 500 can utilize packet processing device 510 to receive or transmit packet traffic. MCC 530 can execute boot, power, management, and manageability software (SW) or firmware (FW) code to boot and initialize the packet processing device 510, manage the device power consumption, provide connectivity to a management controller (e.g., Baseboard Management Controller (BMC)), and other operations.

One or both control planes of ACC 520 and MCC 530 can define traffic routing table content and network topology applied by packet processing circuitry 540 to select a path of a packet in a network to a next hop or to a destination network-connected device. For example, a VM executing on host 500 can utilize packet processing device 510 to receive or transmit packet traffic.

ACC 520 can execute control plane drivers to communicate with MCC 530. At least to provide a configuration and provisioning interface between control planes 522 and 532, communication interface 525 can provide control-plane-to-control plane communications. Control plane 532 can perform a gatekeeper operation for configuration of shared resources. For example, via communication interface 525, ACC control plane 522 can communicate with control plane 532 to perform one or more of: determine hardware capabilities, access the data plane configuration, reserve hardware resources and configuration, communications between ACC and MCC through interrupts or polling, subscription to receive hardware events, perform indirect hardware registers read write for debuggability, flash and physical layer interface (PHY) configuration, or perform system provisioning for different deployments of network interface device such as: storage node, tenant hosting node, microservices backend, compute node, or others.

Communication interface 525 can be utilized by a negotiation protocol and configuration protocol running between ACC control plane 522 and MCC control plane 532. Communication interface 525 can include a general purpose mailbox for different operations performed by packet processing circuitry 540. Examples of operations of packet processing circuitry 540 include issuance of non-volatile memory express (NVMe) reads or writes, issuance of Non-volatile Memory Express over Fabrics (NVMe-oF™) reads or writes, lookaside crypto Engine (LCE) (e.g., compression or decompression), Address Translation Engine (ATE) (e.g., input output memory management unit (IOMMU) to provide virtual-to-physical address translation), encryption or decryption, configuration as a storage node, configuration as a tenant hosting node, configuration as a compute node, provide multiple different types of services between different Peripheral Component Interconnect Express (PCIe) end points, or others.

Communication interface 525 can include one or more mailboxes accessible as registers or memory addresses. For communications from control plane 522 to control plane 532, communications can be written to the one or more mailboxes by control plane drivers 524. For communications from control plane 532 to control plane 522, communications can be written to the one or more mailboxes. Communications written to mailboxes can include descriptors which include message opcode, message error, message parameters, and other information. Communications written to mailboxes can include defined format messages that convey data.

Communication interface 525 can provide communications based on writes or reads to particular memory addresses (e.g., dynamic random access memory (DRAM)), registers, other mailbox that is written-to and read-from to pass commands and data. To provide for secure communications between control planes 522 and 532, registers and memory addresses (and memory address translations) for communications can be available only to be written to or read from by control planes 522 and 532 or cloud service provider (CSP) software executing on ACC 520 and device vendor software, embedded software, or firmware executing on MCC 530. Communication interface 525 can support communications between multiple different compute complexes such as from host 500 to MCC 530, host 500 to ACC 520, MCC 530 to ACC 520, baseboard management controller (BMC) to MCC 530, BMC to ACC 520, or BMC to host 500.

Packet processing circuitry 540 can be implemented using one or more of: application specific integrated circuit (ASIC), field programmable gate array (FPGA), processors executing software, or other circuitry. Control plane 522 and/or 532 can configure packet processing pipeline circuitry 540 or other processors to perform operations related to one or more of: storage access (e.g., NVMe or NVMe-oF reads or writes), lookaside crypto Engine (LCE), Address Translation Engine (ATE), local area network (LAN), remote direct memory access (RDMA), compression/decompression, encryption/decryption, or other accelerated operations.

Various message formats can be used to configure ACC 520 or MCC 530. In some examples, a P4 program can be compiled and provided to MCC 530 to configure packet processing circuitry 540. The following is a JSON configuration file that can be transmitted from ACC 520 to MCC 530 to get capabilities of packet processing circuitry 540 and/or other circuitry in packet processing device 510. More particularly, the file can be used to specify a number of transmit queues, number of receive queues, number of supported traffic classes (TC), number of available interrupt vectors, number of available virtual ports and the types of the ports, size of allocated memory, supported parser profiles, exact match table profiles, packet mirroring profiles, among others.

FIG. 5B depicts an example network interface device system. Various examples of packet processing device or network interface device 510 can utilize components of the system of FIGS. 2, 5, and/or 5A. In some examples, network interface device 510 can be configured to determine whether to store packets in a buffer in memory 584 or in an overflow buffer in a different attached memory device or drop packets and when to egress packets, as described herein. In some examples, packet processing device or network interface device can refer to one or more of: a network interface controller (NIC), a remote direct memory access (RDMA)-enabled NIC, SmartNIC, router, switch, forwarding element, infrastructure processing unit (IPU), or data processing unit (DPU). Network subsystem 560 can be communicatively coupled to compute complex 580. Device interface 562 can provide an interface to communicate with a host. Various examples of device interface 562 can utilize protocols based on Peripheral Component Interconnect Express (PCIe), Compute Express Link (CXL), or others as well as virtual device interface such as virtual device interfaces.

Peripheral Component Interconnect express (PCIe) is described at least in Peripheral Component Interconnect (PCI) Express Base Specification 1.0 (2002), as well as earlier versions, later versions, and variations thereof. Compute Express Link (CXL) is described at least in Compute Express Link Specification revision 2.0, version 0.7 (2019), as well as earlier versions, later versions, and variations thereof.

As described herein, device interface 562 can be configured as a PCIe switch or host interface to provide communications among a host (not shown) as well as circuitry of the network subsystem and compute complex 580. Routing of communications among host (not shown) as well as circuitry of the network subsystem and compute complex 580 can be adjusted by a change of configuration, as described herein.

Interfaces 564 can initiate and terminate at least offloaded remote direct memory access (RDMA) operations, Non-volatile memory express (NVMe) reads or writes operations, and LAN operations. Packet processing pipeline 566 can perform packet processing (e.g., packet header and/or packet payload) based on a configuration and support quality of service (QoS) and telemetry reporting. Inline processor 568 can perform offloaded encryption or decryption of packet communications (e.g., Internet Protocol Security (IPSec) or others). Traffic shaper 570 can schedule transmission of communications. Network interface 572 can provide an interface at least to an Ethernet network by media access control (MAC) and serializer/de-serializer (Serdes) operations.

Cores 582 can be configured to perform infrastructure operations such as storage initiator, Transport Layer Security (TLS) proxy, virtual switch (e.g., vSwitch), or other operations. Memory 584 can store applications and data to be performed or processed. Offload circuitry 586 can perform at least cryptographic and compression operations for host or use by compute complex 580. Offload circuitry 586 can include one or more graphics processing units (GPUs) that can access memory 584. Management complex 588 can perform secure boot, life cycle management and management of network subsystem 560 and/or compute complex 580.

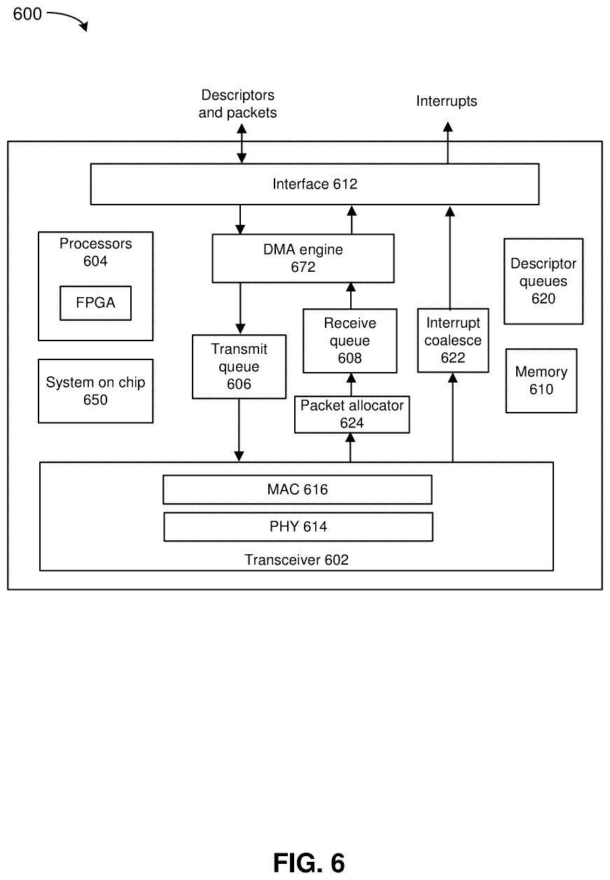

FIG. 6 depicts an example network interface device or packet processing device. In some examples, packet processing device 600 can be implemented as a network interface controller, network interface card, a host fabric interface (HFI), or host bus adapter (HBA), and such examples can be interchangeable. Packet processing device 600 can be coupled to one or more servers using a bus, PCIe, CXL, or Double Data Rate (DDR). Packet processing device 600 may be embodied as part of a system-on-a-chip (SoC) that includes one or more processors, or included on a multichip package that also contains one or more processors.

Some examples of packet processing device 600 are part of an Infrastructure Processing Unit (IPU) or data processing unit (DPU) or utilized by an IPU or DPU. An xPU can refer at least to an IPU, DPU, GPU, GPGPU, or other processing units (e.g., accelerator devices). An IPU or DPU can include a network interface with one or more programmable or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

Network interface 600 can include transceiver 602, processors 604, transmit queue 606, receive queue 608, memory 610, and host interface 612, and DMA engine 652. Transceiver 602 can be capable of receiving and transmitting packets in conformance with the applicable protocols such as Ethernet as described in IEEE 802.3, although other protocols may be used. Transceiver 602 can receive and transmit packets from and to a network via a network medium (not depicted). Transceiver 602 can include PHY circuitry 614 and media access control (MAC) circuitry 616. PHY circuitry 614 can include encoding and decoding circuitry (not shown) to encode and decode data packets according to applicable physical layer specifications or standards. MAC circuitry 616 can be configured to assemble data to be transmitted into packets, that include destination and source addresses along with network control information and error detection hash values.

As described herein, host interface 612 can be configured as a PCIe switch or host interface to provide communications among a host (not shown) as well as circuitry of network interface 600. Routing of communications among host (not shown) as well as circuitry of network interface 600, as described herein.

System on chip (SoC) 650 and processors 604 can include any a combination of: processor, core, graphics processing unit (GPU), field programmable gate array (FPGA), application specific integrated circuit (ASIC), or other programmable hardware device that allow programming of network interface 600. For example, a “smart network interface” can provide packet processing capabilities in the network interface using processors 604.

Processors 604 can include one or more packet processing pipeline that can be configured to perform match-action on received packets to identify packet processing rules and next hops using information stored in a ternary content-addressable memory (TCAM) tables or exact match tables in some embodiments. For example, match-action tables or circuitry can be used whereby a hash of a portion of a packet is used as an index to find an entry. Packet processing pipelines can perform one or more of: packet parsing (parser), exact match-action (e.g., small exact match (SEM) engine or a large exact match (LEM)), wildcard match-action (WCM), longest prefix match block (LPM), a hash block (e.g., receive side scaling (RSS)), a packet modifier (modifier), or traffic manager (e.g., transmit rate metering or shaping). For example, packet processing pipelines can implement access control list (ACL) or packet drops due to queue overflow.

Configuration of operation of processors 604, including its data plane, can be programmed based on one or more of: Protocol-independent Packet Processors (P4), Software for Open Networking in the Cloud (SONiC), Broadcom® Network Programming Language (NPL), NVIDIA® CUDA®, NVIDIA® DOCA™, Infrastructure Programmer Development Kit (IPDK), among others.

Packet allocator 624 can provide distribution of received packets for processing by multiple CPUs or cores using timeslot allocation described herein or RSS. When packet allocator 624 uses RSS, packet allocator 624 can calculate a hash or make another determination based on contents of a received packet to determine which CPU or core is to process a packet.

Interrupt coalesce 622 can perform interrupt moderation whereby network interface interrupt coalesce 622 waits for multiple packets to arrive, or for a time-out to expire, before generating an interrupt to host system to process received packet(s). Receive Segment Coalescing (RSC) can be performed by network interface 600 whereby portions of incoming packets are combined into segments of a packet. Network interface 600 provides this coalesced packet to an application.

Direct memory access (DMA) engine 652 can copy a packet header, packet payload, and/or descriptor directly from host memory to the network interface or vice versa, instead of copying the packet to an intermediate buffer at the host and then using another copy operation from the intermediate buffer to the destination buffer.

Memory 610 can be any type of volatile or non-volatile memory device and can store any queue or instructions used to program network interface 600. Transmit queue 606 can include data or references to data for transmission by network interface. Receive queue 608 can include data or references to data that was received by network interface from a network. Descriptor queues 620 can include descriptors that reference data or packets in transmit queue 606 or receive queue 608. Host interface 612 can provide an interface with host device (not depicted). For example, host interface 612 can be compatible with PCI, PCI Express, PCI-x, Serial ATA, and/or USB compatible interface (although other interconnection standards may be used).

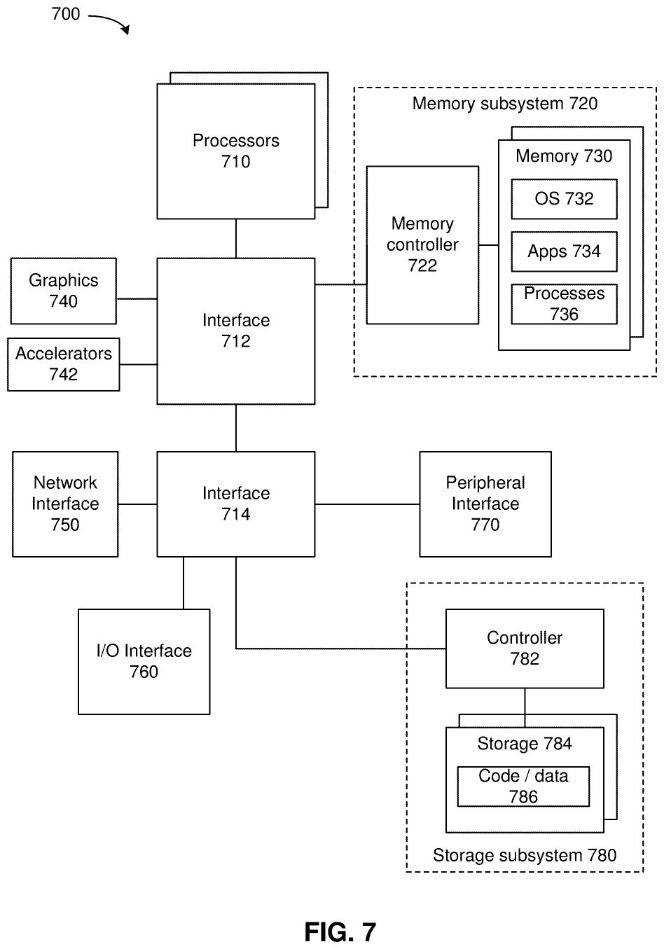

FIG. 7 depicts a system. In some examples, interface 712 and/or 714 can be configured as a PCIe switch or host interface to provide communications among circuitry of system 700. Routing of communications among circuitry of system 700 can be adjusted, as described herein. System 700 includes processor 710, which provides processing, operation management, and execution of instructions for system 700. Processor 710 can include any type of microprocessor, central processing unit (CPU), graphics processing unit (GPU), XPU, processing core, or other processing hardware to provide processing for system 700, or a combination of processors. An XPU can include one or more of: a CPU, a graphics processing unit (GPU), general purpose GPU (GPGPU), and/or other processing units (e.g., accelerators or programmable or fixed function FPGAs). Processor 710 controls the overall operation of system 700, and can be or include, one or more programmable general-purpose or special-purpose microprocessors, digital signal processors (DSPs), programmable controllers, application specific integrated circuits (ASICs), programmable logic devices (PLDs), or the like, or a combination of such devices. Processor 710 can include multiple processors and multiple processors can be embodied as processor sockets.

In one example, system 700 includes interface 712 coupled to processor 710, which can represent a higher speed interface or a high throughput interface for system components, such as memory subsystem 720 or graphics interface components 740, or accelerators 742. Interface 712 represents an interface circuit, which can be a standalone component or integrated onto a processor die. Where present, graphics interface 740 interfaces to graphics components for providing a visual display to a user of system 700. In one example, graphics interface 740 generates a display based on data stored in memory 730 or based on operations executed by processor 710 or both. In one example, graphics interface 740 generates a display based on data stored in memory 730 or based on operations executed by processor 710 or both.

Accelerators 742 can be a programmable or fixed function offload engine that can be accessed or used by a processor 710. For example, an accelerator among accelerators 742 can provide data compression (DC) capability, cryptography services such as public key encryption (PKE), cipher, hash/authentication capabilities, decryption, or other capabilities or services. In some cases, accelerators 742 can be integrated into a CPU socket (e.g., a connector to a motherboard or circuit board that includes a CPU and provides an electrical interface with the CPU). For example, accelerators 742 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 742 can provide multiple neural networks, CPUs, processor cores, general purpose graphics processing units, or graphics processing units can be made available for use by artificial intelligence (AI) or machine learning (ML) models. For example, the artificial intelligence (AI) model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models to perform learning and/or inference operations.

Memory subsystem 720 represents the main memory of system 700 and provides storage for code to be executed by processor 710, or data values to be used in executing a routine. Memory subsystem 720 can include one or more memory devices 730 such as read-only memory (ROM), flash memory, one or more varieties of random access memory (RAM) such as DRAM, or other memory devices, or a combination of such devices. Memory 730 stores and hosts, among other things, operating system (OS) 732 to provide a software platform for execution of instructions in system 700. Additionally, applications 734 can execute on the software platform of OS 732 from memory 730. Applications 734 represent programs that have their own operational logic to perform execution of one or more functions. Processes 736 represent agents or routines that provide auxiliary functions to OS 732 or one or more applications 734 or a combination. OS 732, applications 734, and processes 736 provide software logic to provide functions for system 700. In one example, memory subsystem 720 includes memory controller 722, which is a memory controller to generate and issue commands to memory 730. It will be understood that memory controller 722 could be a physical part of processor 710 or a physical part of interface 712. For example, memory controller 722 can be an integrated memory controller, integrated onto a circuit with processor 710.

Applications 734 and/or processes 736 can refer instead or additionally to a virtual machine (VM), container (e.g., Docker container), microservice, processor, or other software. Various examples described herein can perform an application composed of microservices, where a microservice runs in its own process and communicates using protocols (e.g., application program interface (API), a Hypertext Transfer Protocol (HTTP) resource API, message service, remote procedure calls (RPC), or Google RPC (gRPC)). Microservices can communicate with one another using a service mesh and be executed in one or more data centers or edge networks. Microservices can be independently deployed using centralized management of these services. The management system may be written in different programming languages and use different data storage technologies. A microservice can be characterized by one or more of: polyglot programming (e.g., code written in multiple languages to capture additional functionality and efficiency not available in a single language), or lightweight container or virtual machine deployment, and decentralized continuous microservice delivery.

In some examples, OS 732 can be Linux®, FreeBSD, Windows® Server or personal computer, FreeBSD®, Android®, MacOS®, iOS®, VMware vSphere, openSUSE, RHEL, CentOS, Debian, Ubuntu, or any other operating system. The OS and driver can execute on a processor sold or designed by Intel®, ARM®, AMD®, Qualcomm®, IBM®, Nvidia® Broadcom®, Texas Instruments®, among others.

While not specifically illustrated, it will be understood that system 700 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 700 includes interface 714, which can be coupled to interface 712. In one example, interface 714 represents an interface circuit, which can include standalone components and integrated circuitry. In one example, multiple user interface components or peripheral components, or both, couple to interface 714. Network interface 750 provides system 700 the ability to communicate with remote devices (e.g., servers, workstations, or other computing devices) over one or more networks. Network interface 750 can include an Ethernet adapter, wireless interconnection components, cellular network interconnection components, USB (universal serial bus), or other wired or wireless standards-based or proprietary interfaces. Network interface 750 can transmit data to a device that is in the same data center or rack or a remote device, which can include sending data stored in memory. Network interface 750 can receive data from a remote device, which can include storing received data into memory. In some examples, packet processing device or network interface device 750 can refer to one or more of: a network interface controller (NIC), a remote direct memory access (RDMA)-enabled NIC, SmartNIC, router, switch, forwarding element, infrastructure processing unit (IPU), or data processing unit (DPU). An example IPU or DPU is described herein.

In one example, system 700 includes one or more input/output (I/O) interface(s) 760. I/O interface 760 can include one or more interface components through which a user interacts with system 700. Peripheral interface 770 can include any hardware interface not specifically mentioned above. Peripherals refer generally to devices that connect dependently to system 700.

In one example, system 700 includes storage subsystem 780 to store data in a nonvolatile manner. In one example, in certain system implementations, at least certain components of storage 780 can overlap with components of memory subsystem 720. Storage subsystem 780 includes storage device(s) 784, which can be or include any conventional medium for storing large amounts of data in a nonvolatile manner, such as one or more magnetic, solid state, or optical based disks, or a combination. Storage 784 holds code or instructions and data 786 in a persistent state (e.g., the value is retained despite interruption of power to system 700). Storage 784 can be generically considered to be a “memory,” although memory 730 is typically the executing or operating memory to provide instructions to processor 710. Whereas storage 784 is nonvolatile, memory 730 can include volatile memory (e.g., the value or state of the data is indeterminate if power is interrupted to system 700). In one example, storage subsystem 780 includes controller 782 to interface with storage 784. In one example controller 782 is a physical part of interface 714 or processor 710 or can include circuits or logic in both processor 710 and interface 714.

A volatile memory can include memory whose state (and therefore the data stored in it) is indeterminate if power is interrupted to the device. A non-volatile memory (NVM) device can include a memory whose state is determinate even if power is interrupted to the device.

In some examples, system 700 can be implemented using interconnected compute platforms of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe (e.g., a non-volatile memory express (NVMe) device can operate in a manner consistent with the Non-Volatile Memory Express (NVMe) Specification, revision 1.3c, published on May 24, 2018 (“NVMe specification”) or derivatives or variations thereof).

Communications between devices can take place using a network that provides die-to-die communications; chip-to-chip communications; circuit board-to-circuit board communications; and/or package-to-package communications. Die-to-die communications can utilize Embedded Multi-Die Interconnect Bridge (EMIB) or an interposer. Components of examples described herein can be enclosed in one or more semiconductor packages. A semiconductor package can include metal, plastic, glass, and/or ceramic casing that encompass and provide communications within or among one or more semiconductor devices or integrated circuits. Various examples can be implemented in a die, in a package, or between multiple packages, in a server, or among multiple servers. A system in package (SiP) can include a package that encloses one or more of: an SoC, one or more tiles, or other circuitry.

In an example, system 700 can be implemented using interconnected compute platforms of processors, memories, storages, network interfaces, and other components. High speed interconnects can be used such as PCIe, Ethernet, or optical interconnects (or a combination thereof).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. For example, descriptions using the terms “connected” and/or “coupled” may indicate that two or more elements are in direct physical or electrical contact. The term “coupled,” however, may also mean that two or more elements are not in direct contact, but yet still co-operate or interact.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to be present. Additionally, conjunctive language such as the phrase “at least one of X, Y, and Z,” unless specifically stated otherwise, should also be understood to mean X, Y, Z, or any combination thereof, including “X, Y, and/or Z.”

Illustrative examples of the devices, systems, and methods disclosed herein are provided below. An embodiment of the devices, systems, and methods may include any one or more, and any combination of, the examples described below.

Example 1 includes one or more examples and includes an apparatus that includes: a network interface device that includes: a host interface; a network interface; and a direct memory access (DMA) circuitry, wherein the host interface that includes: circuitry to: apply a first configuration of Peripheral Component Interconnect Express (PCIe) upstream ports and downstream ports and without reboot of the network interface device, apply a second configuration to adjust routing of communication among devices coupled to the PCIe upstream ports and downstream ports.

Example 2 includes one or more examples, wherein: the circuitry that includes multiple PCIe switches and a microcontroller and the microcontroller is configured to process a PCIe configuration packet or route the PCIe configuration packet to a processor.

Example 3 includes one or more examples, wherein: the circuitry that includes multiple PCIe switches and a microcontroller and the microcontroller is to configure bus range registers to define a PCIe identifier bus range to forward identifier-based routing Transaction Layer Packets (TLPs) through a fabric to an endpoint.

Example 4 includes one or more examples, wherein: the circuitry that includes multiple PCIe switches and a microcontroller and the microcontroller is to configure content of memory base and memory limit registers are to define memory mapped address ranges to forward memory transactions from a host connected to one or more of the devices through a fabric.

Example 5 includes one or more examples, wherein: the circuitry that includes multiple PCIe switches and a microcontroller and the microcontroller is to configure content of memory space base address register (BAR) to determine a destination of a memory request.

Example 6 includes one or more examples, wherein the circuitry is to: without reboot of the network interface device, apply a third configuration of PCIe endpoints to remove a second device from connection to a second PCIe endpoint of the PCIe endpoints.

Example 7 includes one or more examples, wherein the devices comprise: a storage device, a network interface device, an accelerator, or a processor.

Example 8 includes one or more examples, wherein the circuitry that includes a PCIe switch port to connect to one or more PCIe root ports and one or more PCIe endpoints.

Example 9 includes one or more examples, that includes a host processor coupled to the circuitry, wherein the host processor is to access, as a PCIe root port, one or more of the devices.

Example 10 includes one or more examples, and includes the devices, wherein at least one of the devices is accessible as a PCIe endpoint.

Example 11 includes one or more examples, and includes a process of making a host interface in a network interface device comprising: connecting a first port to a fabric and connecting a second port to the fabric, wherein: the host interface applies a first configuration of Peripheral Component Interconnect Express (PCIe) upstream ports and downstream ports and without reboot of the network interface device, the host interface applies a second configuration to adjust routing of communication among devices coupled to the PCIe upstream ports and downstream ports.

Example 12 includes one or more examples, wherein the host interface that includes a micro-controller that executes a firmware that applies the second configuration.

Example 13 includes one or more examples, wherein the second configuration adjusts a PCIe tree of a topology of connected devices.

Example 14 includes one or more examples, wherein the second configuration removes a device from connection to one of the PCIe upstream ports and downstream ports.

Example 15 includes one or more examples, and includes at least one non-transitory computer-readable medium comprising instructions stored thereon, that if executed by one or more processors of a host interface in a network interface device, cause the one or more processors to: without reboot of the network interface device, adjust routing of communication among devices coupled to Peripheral Component Interconnect Express (PCIe) upstream ports and downstream ports.

Example 16 includes one or more examples, wherein: the host interface that includes multiple PCIe switches and a microcontroller and the microcontroller is configured to process a PCIe configuration packet or route the PCIe configuration packet to a processor.

Example 17 includes one or more examples, wherein: the host interface that includes multiple PCIe switches and a microcontroller and the microcontroller is to configure bus range registers to define a PCIe identifier bus range to forward identifier-based routing Transaction Layer Packets (TLPs) through a fabric to an endpoint.

Example 18 includes one or more examples, and includes instructions stored thereon, that if executed by one or more processors of a host interface in a network interface device, cause the one or more processors to: without reboot of the network interface device, apply a third configuration of PCIe endpoints to remove a second device from connection to a second PCIe endpoint of the PCIe endpoints.

Example 19 includes one or more examples, wherein the devices comprise: a storage device, a network interface device, an accelerator, or a processor.

Example 20 includes one or more examples, wherein the host interface that includes a PCIe switch port to connect to one or more PCIe root ports and one or more PCIe endpoints.

1. An apparatus comprising:
a network interface device comprising:
a host interface;
a network interface; and
a direct memory access (DMA) circuitry, wherein the host interface comprises:
circuitry to:
apply a first configuration of Peripheral Component Interconnect Express (PCIe) upstream ports and downstream ports and
without reboot of the network interface device, apply a second configuration to adjust routing of communication among devices coupled to the PCIe upstream ports and downstream ports.

2. The apparatus of claim 1, wherein:
the circuitry comprises multiple PCIe switches and a microcontroller and
the microcontroller is configured to process a PCIe configuration packet or route the PCIe configuration packet to a processor.

3. The apparatus of claim 1, wherein:
the circuitry comprises multiple PCIe switches and a microcontroller and
the microcontroller is to configure bus range registers to define a PCIe identifier bus range to forward identifier-based routing Transaction Layer Packets (TLPs) through a fabric to an endpoint.

4. The apparatus of claim 1, wherein:
the circuitry comprises multiple PCIe switches and a microcontroller and
the microcontroller is to configure content of memory base and memory limit registers are to define memory mapped address ranges to forward memory transactions from a host connected to one or more of the devices through a fabric.

5. The apparatus of claim 1, wherein:
the circuitry comprises multiple PCIe switches and a microcontroller and
the microcontroller is to configure content of memory space base address register (BAR) to determine a destination of a memory request.

6. The apparatus of claim 1, wherein the circuitry is to:
without reboot of the network interface device, apply a third configuration of PCIe endpoints to remove a second device from connection to a second PCIe endpoint of the PCIe endpoints.

7. The apparatus of claim 1, wherein the devices comprise: a storage device, a network interface device, an accelerator, or a processor.

8. The apparatus of claim 1, wherein the circuitry comprises a PCIe switch port to connect to one or more PCIe root ports and one or more PCIe endpoints.

9. The apparatus of claim 1, comprising a host processor coupled to the circuitry, wherein the host processor is to access, as a PCIe root port, one or more of the devices.

10. The apparatus of claim 1, comprising the devices, wherein at least one of the devices is accessible as a PCIe endpoint.

11. A process of making a host interface in a network interface device comprising:
connecting a first port to a fabric and
connecting a second port to the fabric, wherein:
the host interface applies a first configuration of Peripheral Component Interconnect Express (PCIe) upstream ports and downstream ports and
without reboot of the network interface device, the host interface applies a second configuration to adjust routing of communication among devices coupled to the PCIe upstream ports and downstream ports.

12. The process of claim 11, wherein the host interface comprises a micro-controller that executes a firmware that applies the second configuration.

13. The process of claim 11, wherein the second configuration adjusts a PCIe tree of a topology of connected devices.

14. The process of claim 11, wherein the second configuration removes a device from connection to one of the PCIe upstream ports and downstream ports.

15. At least one non-transitory computer-readable medium comprising instructions stored thereon, that if executed by one or more processors of a host interface in a network interface device, cause the one or more processors to:
without reboot of the network interface device, adjust routing of communication among devices coupled to Peripheral Component Interconnect Express (PCIe) upstream ports and downstream ports.

16. The computer-readable medium of claim 15, wherein:
the host interface comprises multiple PCIe switches and a microcontroller and
the microcontroller is configured to process a PCIe configuration packet or route the PCIe configuration packet to a processor.

17. The computer-readable medium of claim 15, wherein:
the host interface comprises multiple PCIe switches and a microcontroller and
the microcontroller is to configure bus range registers to define a PCIe identifier bus range to forward identifier-based routing Transaction Layer Packets (TLPs) through a fabric to an endpoint.

18. The computer-readable medium of claim 15, comprising instructions stored thereon, that if executed by one or more processors of a host interface in a network interface device, cause the one or more processors to:
without reboot of the network interface device, apply a third configuration of PCIe endpoints to remove a second device from connection to a second PCIe endpoint of the PCIe endpoints.

19. The computer-readable medium of claim 15, wherein the devices comprise: a storage device, a network interface device, an accelerator, or a processor.

20. The computer-readable medium of claim 15, wherein the host interface comprises a PCIe switch port to connect to one or more PCIe root ports and one or more PCIe endpoints.
